(19) United States
(12) Patent Application Publication
(10) Pub. No.: US 2023/0005360 A1
(43) Pub. Date: Jan. 5, 2023

(54) SYSTEMS AND METHODS FOR AUTOMATICALLY DETECTING AND RESPONDING TO A SECURITY EVENT USING A MACHINE LEARNING INFERENCE-CONTROLLED SECURITY DEVICE

(71) Applicant: iGuard.ai, Inc., Dublin, CA (US)

(72) Inventor: Shangde Zhou, Dublin, CA (US)

(21) Appl. No.: 17/836,047

(22) Filed: Jun. 9, 2022

Related U.S. Application Data
(60) Provisional application No. 63/216,841, filed on Jun. 30, 2021.

(51) Int. Cl. G08B 31/00; G06N 5/04; G08B 13/00

(52) U.S. Cl. CPC G08B 31/00; G06N 5/046; G08B 13/00

(57) ABSTRACT

A system and method for intelligently evaluating and automatically mitigating detected security activities includes implementing an on-premise security device that detects a potential security activity at a property of a subscriber; establishing a security channel between the on-premise security device and a remote machine learning-based security module operating in a cloud computing environment if the potential security activity satisfies escalation criteria; automatically transmitting, via the security channel, sensor data from the on-premise security device to the remote machine learning-based security module; computing, by the remote machine learning-based security module, a threat severity inference based on the sensor data; deriving device control instructions based on the threat severity inference; transmitting, via the security channel, the device control instructions to the on-premise security device; and mitigating the potential security activity by executing the device control instructions at the on-premise device.

### CROSS-REFERENCE TO RELATED APPLICATIONS

This application claims the benefit of U.S. Provisional Application No. 63/216,841, filed on 30 Jun. 2021, which is incorporated in its entirety by this reference.

### TECHNICAL FIELD

This invention relates generally to the security system and security camera field, more specifically, a new and useful system and method for detecting and automatically mitigating potential security threats/activities.

### BACKGROUND

Property security is a concern for many homeowners and businesses. Those seeking to secure their property often use conventional security systems. These conventional security systems may be configured to detect potential burglaries, intrusions, and other criminal activity. When a conventional security system detects a potential security event, the conventional security system will transmit an alert/notification to a property owner or designated security response team, thus allowing the property owner or designated security response team to properly address the detected potential security event.

However, this alert/notification may be inadvertently overlooked and left unaddressed if the property owner and/or the designated security response team are pre-occupied. Of course, such an oversight by the property owner or designated security response team may put a relevant party at a greater risk of harm-which are contrary to the goals of a security system. Accordingly, it is advantageous to have systems and methods that reduce the need of human involvement in addressing/mitigating detected security events/activities.

The embodiments of the present application described herein provide technical solutions that address, at least, the needs described above, as well as the deficiencies of the state of the art.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application; and

FIG. 3 illustrates an example schematic for automatically mitigating a potential security activity detected by a surveillance sensing device.

### BRIEF SUMMARY OF THE INVENTION(S)

In some embodiments, a method for intelligently evaluating and automatically mitigating detected security activities includes: implementing an on-premise security device that detects a potential security activity at a property of a subscriber based on sensing a dynamic object within a defined range of the on-premise security device; establishing a security channel between the on-premise security device and a remote machine learning-based security module operating in a cloud computing environment if the potential security activity satisfies escalation criteria; automatically transmitting, via the security channel, sensor data from the on-premise security device to the remote machine learning-based security module; computing, by the remote machine learning-based security module, a threat severity inference based on the sensor data, wherein the threat severity inference relates to a machine learning-based probability that the potential security activity poses a threat to the property of the subscriber or to an object/person associated with the property; deriving device control instructions based on the threat severity inference, wherein the device control instructions, when executed, informs a response of the on-premise security device to the potential security event; transmitting, via the security channel, the device control instructions to the on-premise security device; and mitigating the potential security activity by executing the device control instructions at the on-premise device.

In some embodiments, the potential security activity satisfies the escalation criteria if the on-premise security device determines that the potential security activity involves at least one human body. In some embodiments, the potential security activity satisfies the escalation criteria if the on-premise security device determines that the potential security activity occurred after a pre-determined time of day.

In some embodiments the escalation criteria is defined by the subscriber. In some embodiments, the method further includes receiving, from the subscriber, an input including one or more criteria defining when a target potential security activity satisfies and does not satisfy the escalation criteria; and in response to receiving the input, setting the escalation criteria based on the one or more criteria provided by the subscriber.

In some embodiments, the method includes determining that the potential security activity does not satisfy the escalation criteria; and in response to determining that the potential security activity does not satisfy the escalation criteria, forgoing transmitting the sensor data to the machine learning-based security module.

In some embodiments, the on-premise security device includes at least one camera and at least one microphone, and the sensor data from the on-premise security device includes data identified by the at least one camera and the at least one microphone when the potential security activity was detected.

In some embodiments, the remote machine learning-based security module includes a plurality of machine learning-based submodules, including a first machine learning-based submodule that computes the threat severity inference and one or more other machine learning-based submodules that contextualize the potential security activity. In some embodiments, the method further includes before computing the threat severity inference, generating one or more contextual inferences for the potential security activity by providing the sensor data transmitted from the on-premise security device to the one or more other machine learning-based submodules; routing the one or more contextual inferences as input to the first machine learning-based submodule; and computing, via the first machine learning-based submodule, the threat severity inference based on the one or more contextual inferences provided as input.

In some embodiments, the sensor data includes audio/video (AV) surveillance data of the potential security activity, the one or more other machine learning-based submodules that contextualize the potential security activity implement at least a weapon detection machine learning model, and generating the one or more contextual inferences for the potential security activity includes: providing, as input to the weapon detection machine learning model, one or more video frames and/or audio data underpinning the audio/video surveillance data; and producing, via the weapon detection machine learning model, a contextual inference indicating a likelihood the audio/video surveillance data includes at least one weapon based on the one or more video frames and/or audio data.

In some embodiments, the sensor data is audio/video (AV) surveillance data of the potential security activity, the one or more other machine-learning based submodules that contextualize the potential security activity implement at least an identity recognition machine learning model, and generating the one or more contextual inferences for the potential security activity includes: providing, as input to the identity recognition machine learning model, one or more video frames and/or audio data underpinning the audio/video surveillance data; and producing, via the identity recognition machine learning model, one or more contextual inferences indicating an estimated identity of each body in the audio/video surveillance data based on the one or more video frames and/or audio data.

In some embodiments, the identity recognition machine learning model is trained to recognize identities based on facial images previously provided by the subscriber. In some embodiments, the method further includes determining that the identity recognition machine learning model could not recognize an identity for at least one body in the audio/video surveillance data; and in response to determining that the identity recognition machine learning could not recognize the identity for the at least one body in the audio/video surveillance data: querying a public safety awareness registry based on an extracted image of a face of the at least one body; and deriving an identity of the at least one body if the extracted image of the face of the at least one body matches an image of a face stored in the public safety awareness registry.

In some embodiments, the sensor data is audio/video (AV) surveillance data of the potential security activity, the one or more other machine learning-based submodules that contextualize the potential security activity implement an acoustic threat detection machine learning model, and generating the one or more contextual inferences for the potential security activity includes: providing, as input to the acoustic threat detection machine learning model, one or more audio frames and/or audio data underpinning the audio/video surveillance data; and producing, via the acoustic threat detection machine learning model, a contextual inference indicating a likelihood the audio/video surveillance data includes at least one acoustic threat based on the one or more audio frames and/or audio data.

In some embodiments, deriving device control instructions based on the threat severity inference includes: in accordance with a determination that the threat severity inference indicates a first probability that the potential security activity poses a threat, selecting a first set of device control instructions for mitigating the potential security activity; and in accordance with a determination that the threat severity inference indicates a second probability that the potential security activity poses a threat, selecting a second set of device control instructions for mitigating the potential security activity, different from the first set of device control instructions.

In some embodiments, the method further includes, after computing the threat severity inference: determining that the machine learning-based probability indicated by the threat-severity inference exists within a predefined probability range, wherein the predefined probability range only includes probabilities that ambiguously indicate whether the potential security activity poses a threat to the property of the subscriber or to an object/person associated with the property; deriving device control instructions based on the threat severity inference, including deriving one or more intent-discovery questions; transmitting, via the security channel, the device control instructions, including the one or more intent-discovery questions; playing, via one or more speakers of the on-premise security device, the one or more intent-discovery questions; collecting, via a microphone of the on-premise security device, responses to the one or more intent-discovery questions; transmitting, via the security channel, the responses to the one or more intent-discovery questions to the remote machine learning-based security module; and computing, via the remote machine learning-based security module; a new threat-severity inference for potential security activity based on the responses to the one or more intent-discovery questions.

In some embodiments, the method further includes, after computing the new threat-severity inference, deriving new device control instructions based on the new threat-severity inference, wherein the new threat severity inference relates to a machine learning-based probability that the potential security activity poses a threat to the property of the subscriber or to an object/person associated with the property; transmitting, via the security channel, the new device control instructions to the on-premise security device; and mitigating the potential security activity by executing the new device control instructions at the on-premise device.

In some embodiments, the remote machine learning-based security module includes a plurality of machine learning-based submodules, including one or more machine learning-based submodules that contextualize the potential security activity. In some embodiments, the method further includes before deriving the one or more intent-discovery questions, generating one or more contextual inferences for the potential security activity by providing the sensor data transmitted from the on-premise security device to the one or more machine learning-based submodules; and after generating the one or more contextual inferences, deriving the one or more intent-discovery questions based at least on the one or more contextual inferences.

In some embodiments, the method further includes, after computing the threat severity inference, determining that the machine learning-based probability indicated by the threat-severity inference exists within a predefined probability range, wherein the predefined probability range only includes probabilities that indicate the potential security activity does not pose a threat to the property of the subscriber or to an object/person associated with the property; and forgoing deriving the device control instructions and transmitting the device control instructions to the on-premise security device based on determining that the potential security activity does not pose a threat to the property of the subscriber or to the object/person associated with the property.

In some embodiments, implementing the on-premise security device includes an on-device software agent at the on-premise security device, separate from default operating system components of the on-premise security device. In some embodiments, the on-premise security device is a security camera.

In some embodiments, the method includes detecting, via one or more surveillance sensing devices, a potential security activity involving at least one human body; identifying, via the one or more surveillance sensing devices, audio/video surveillance data of the potential security activity; streaming the audio/video surveillance data of the potential security activity to a cloud-based threat assessment module; performing, at the cloud-based threat assessment module, a threat-severity assessment for the potential security activity based on the audio/video surveillance data, wherein performing the threat-severity assessment for the potential security activity includes: providing, to one or more machine learning models instantiated in the cloud-based threat assessment module, one or more image and/or audio frames underpinning the audio/video surveillance data as input; generating, via the one or more machine learning models, one or more threat-informative inferences based on the one or more image and/or audio frames provided as input; and assigning a threat-severity score to the potential security activity based on the one or more threat-informative inferences; engaging in an automated-conversational dialogue with the at least one human body involved in the potential security activity based on determining that the threat-severity score exists within a pre-determined threat-severity score range; assigning a new threat-severity score to the potential security activity based on the automated-conversational dialogue with the at least one human body; and automatically executing, via the one or more surveillance sensing devices, one or more security actions that mitigate the potential security activity based on the new threat-severity score assigned to the potential security activity.

In some embodiments, the method includes while one or more surveillance sensing devices are surveilling a property of a subscriber, detecting a potential security activity at the property of the subscriber based on movement occurring within a sensing range of the one or more surveillance sensing devices; determining that the potential security activity satisfies surveillance transmission criteria, wherein the potential security activity is determined to satisfy the surveillance transmission criteria if the potential security activity involves at least one human body; identifying, via the one or more surveillance sensing devices, audio/video surveillance data of the potential security activity based on determining that the potential security activity satisfies the surveillance transmission criteria; transmitting the audio/video surveillance data of the potential security activity to a cloud-based security threat evaluation system for enhanced analysis of the potential security activity, wherein performing enhanced analysis of the potential security activity via the cloud-based security threat evaluation system includes: generating, via one or more machine learning models of the cloud-based surveillance threat evaluation system, one or more threat-informative inferences based on the audio/video surveillance data of the potential security activity; and computing an aggregate threat-based severity score for the potential security activity based on the one or more threat-informative inferences; prompting one or more intent-discovery questions to the at least one human body involved in the potential security activity based on determining that the aggregated threat-based severity score ambiguously indicates a maliciousness of the potential security activity; updating the aggregate threat-based severity score assigned to the potential security activity based at least on responses provided to the one or more intent-discovery questions from the at least one human body; and automatically executing, via the one or more surveillance sensing devices, one or more security actions that mitigate the potential security activity based on the updating of the aggregate threat-based severity score.

### DESCRIPTION OF THE PREFERRED EMBODIMENTS

The following description of the preferred embodiments of the inventions are not intended to limit the inventions to these preferred embodiments, but rather to enable any person skilled in the art to make and use these inventions.

### 1.00 AI Surveillance & Security System

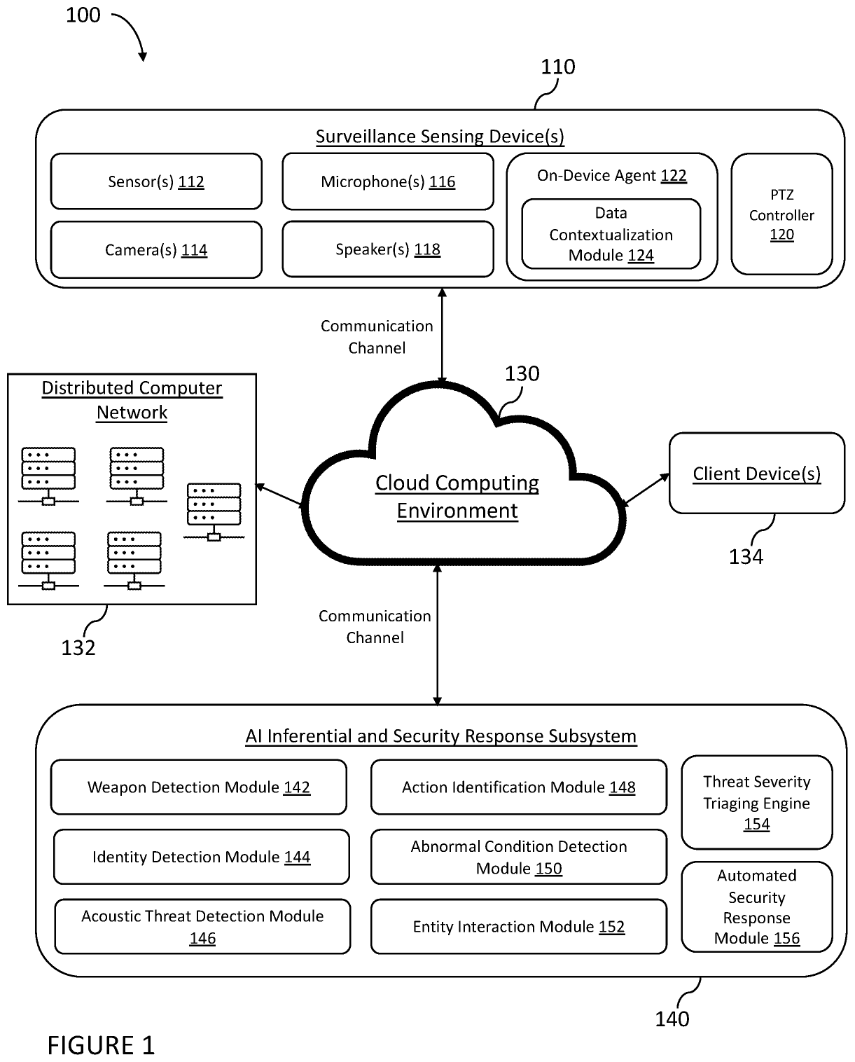

As shown in FIG. 1, an AI surveillance and security system 100 may include one or more surveillance sensing devices 110, a cloud computing environment 130 whose computing resources are distributed over one or more computer networks (e.g., distributed computer network 132), one or more client devices 134, and an AI inference and security response subsystem 140.

### 1.10 Surveillance Sensing Device(s)

The one or more surveillance sensing devices 110 of the system 100 may be on-premise security devices that passively or actively surveil one or more pre-determined locations or areas, such as an entrance of a dwelling, a side entrance of the dwelling, a back entrance of the dwelling, and/or the like. The one or more surveillance sensing devices no may also be installed at non-residence properties or structures, such as a business office, a storage facility, or the like.

While the one or more surveillance sensing devices no are installed at the one or more pre-determined locations/areas, the one or more surveillance sensing devices no may function to detect a potential security activity occurring at the one or more pre-determined locations via one or more sensors 112 of the one or more surveillance sensing devices no.

In some examples, the one or more sensors 112 of the one or more surveillance sensing devices no may comprise one or more motion sensors, one or more heat sensors, one or more proximity sensors, one or more light sensors, and/or the like. Accordingly, in some such examples, the one or more sensors 112 may function to collectively define a sensing region/range in which a potential security activity can be detected and/or may function to detect a potential security activity when the one or more sensors 112 detect a change in heat, light, motion, or the like within the sensing region/range.

After the one or more sensors 112 of the one or more surveillance sensing devices 110 detect a potential security activity, the one or more surveillance sensing devices 110 may automatically begin transmitting audio/video (AV) surveillance data of the potential security activity obtained via one or more cameras 114 and/or via one or more microphones 116 of the one or more surveillance sensing devices 110. The one or more cameras 114 may preferably include at least one high definition (HD) video camera that can produce video images at a display resolution of 720p, 1080p, or better. Similarly, the one or more microphones 116 of the one or more surveillance sensing devices 110 may also preferably include at least one microphone capable of identifying audio signals having frequencies between 80 Hz and 15 kHz.

Alternatively, in some examples, after the one or more sensors 112 detect a potential security activity, the one or more surveillance sensing devices 110 may not immediately begin transmitting AV surveillance data of the potential security activity. Rather, in some such examples, the one or more surveillance sensing devices 110 may only start transmitting AV surveillance data of the potential security activity after determining that the potential security activity satisfies surveillance transmission criteria.

In one example, the one or more surveillance sensing devices 110 may determine that the potential security activity satisfies surveillance transmission criteria if the potential security activity involves at least one human body. It shall be noted that the above example is not intended to be limiting and that the surveillance transmission criteria may be based on additional, fewer, or different criterion without departing from the scope of the disclosure.

In some embodiments, to determine if a detected potential security activity satisfies surveillance transmission criteria, one of the one or more surveillance sensing devices 110 (e.g., a designated “master” surveillance sensing device) may function to utilize a sub-module of an on-device agent 122, such a data contextualization module 124. The data contextualization module 124 may include one or more pre-trained machine learning models that aid in determining whether the potential security activity satisfies surveillance transmission criteria. For instance, if the potential security activity satisfies the surveillance transmission criteria based on whether the potential security activity involves at least one human body, the designated “master” surveillance sensing device may function to utilize a light-weight body-detection machine learning model implemented at the surveillance data contextualization module 124 to determine if the potential security activity involves at least one human body.

The on-device agent 122, as described in more detail in method 200, may be included in each of the one or more surveillance sensing devices 110 and may provide other additional functions, including but not limited to, establishing a bi-direction communication channel with one or more remote servers (e.g., cloud computing environment 130), receiving control instructions from the AI Inference and Security Response Subsystem 140, and/or executing received control instructions via one or more components of a surveillance sensing device (e.g., speaker(s) 118, Pan-Tilt-Zoom (PTZ) Controller 120, or the like).

### 1.30 Cloud Computing Environment

While or after identifying AV surveillance data of a detected potential security activity, each of the one or more surveillance sensing devices no may establish a bi-directional communication channel with the cloud computing environment 130. The bi-direction communication channel may enable the one or more surveillance sensing devices no to stream the AV surveillance data to a subsystem hosted in the cloud computing environment 130 for real-time or near real-time evaluation, such as the AI inference and security response subsystem 140. Additionally, the bi-direction communication channel may also enable device control instructions to be transmitted from the AI inference and security response subsystem 140 to the one or more surveillance sensing devices no for appropriate mitigation of the potential security activity.

The cloud computing environment 130 may comprise one or more “public” cloud computing environments, one or more “private” cloud computing environments, one or more “hybrid” cloud environments, and/or one or more “multi-cloud” environments. The cloud computing environment 130 may utilize infrastructure components/computing resources obtained from a cloud service provider (e.g., Amazon Web Services (AWS), Google Cloud Platform (GCP), IBM Cloud, or Microsoft Azure).

In a preferred example, the computing resources of the cloud computing environment may be located over a scalable distributed computer network 132. The distributed computer network 132 may include one or more cloud computing nodes that collectively function to process requests from the one or more surveillance sensing devices no, one or more client devices 134 (e.g., a client smartphone, mobile telephone, computer, or the like), and/or the AI inference and security response subsystem 140.

It shall be noted that, in some examples, each of the one or more cloud computing nodes underpinning the distributed computer network 132 may be a plurality of distinct servers (or rack of servers) that are operably connected to each other.

### 1.40 AI Inference and Security Response Subsystem

In some examples of system 100, after the one or more surveillance sensing devices 110 establish the bi-directional communication channel with the cloud computing environment 130, the distributed computer network 132 may function to instantiate the AI inference and security response subsystem 140 (if not previously instantiated) or wake the AI inference and security response subsystem 140 (if previously instantiated). The AI inference and security response subsystem 140 may function to compute one or more threat-informative inferences based on the AV surveillance data received by the cloud computing environment 130, estimate a severity of the activity included in the AV surveillance data based on the computed one or more threat-informative inferences, and/or function to transmit device control instructions to the one or more surveillance sensing devices no for addressing/handling the activity identified in the AV surveillance data. Further description of the AI inference and security response subsystem 140 will be provided in method 200.

Additionally, it shall also be noted that while FIG. 1 shows the AI inference and security response subsystem 140 and the cloud computing environment 130 being distinct from one another, the AI inference and security response subsystem 140, in other embodiments, may be contained within the cloud computing environment 130. Although not shown, the AI inference and security response subsystem 140 may include and/or be in operable communication with an automatic speech recognition (ASR) module and/or a text-to-speech (TTS) module. In operation, in some embodiments, the ASR module may function to recognize and translate audio data containing speech provided by a user or the like in an activity to text that, in turn, may be used as model input for generating one or more threat inferences by the AI inference and security response subsystem 140. The TTS module, in use, may function to receive device control instructions or the like from the AI inference and security response subsystem 140 for converting text data to audio data or audible speech. Accordingly, in one or more embodiments, the one or more surveillance sensing devices 110 may include a TTS module for converting text data or similar instructions to speech for engaging with a user or the like.

In some examples, computing threat-informative inferences for the received AV surveillance data may include computing one or more inferences relating to a probability that the received AV surveillance data includes one or more classes of weapons, computing one or more inferences relating to an identity of one or more bodies identified in the AV surveillance data, computing one or more inferences relating to a probability that the AV surveillance data includes one or more violent or threatening sounds, computing one or more inferences relating to an action being performed by each body detected in the received AV surveillance data, computing one or more inferences relating to a probability that the AV surveillance data includes one or more atypical conditions (e.g., fire, smoke, or the like), and/or the like. In some examples, these one or more inferences may be computed via modules 142-152, which are described in more detail in method 200.

In some examples, after computing one or more threat-informative inferences for the received AV surveillance data, the AI inference and security response subsystem 140 may function to compute, via the threat severity triaging engine 154, a threat-severity score for the activity identified in the received AV surveillance data (and/or classify the activity in the surveillance as “malicious” or “non-malicious”) based on the one or more computed threat-informative inferences.

In a first implementation, to estimate a severity of the activity identified in the surveillance data, the threat-severity triaging engine 154 may function to implement a severity-aware machine learning ensemble specifically trained to compute a threat severity score and/or classify the intent of the activity identified in the AV surveillance data as malicious or non-malicious. In some such embodiments, the AI inference and security response subsystem 140 may function to provide one or more of the above-described threat-informative inferences to the severity-aware machine learning ensemble, which in turn, may cause the severity-aware machine learning ensemble to produce a threat-severity score based on the provided input.

The threat-severity score produced by the severity-aware machine learning model may be scaled between 0-100, wherein a threat-severity score of 0 indicates a 0% probability that activity identified in the AV surveillance data contains malicious activity and a threat-severity score of 100 indicates a 100% probability that the activity identified in the AV surveillance data contains malicious activity.

Additionally, in some embodiments, the AI inference and security response subsystem 140 may include an automated security response module 156. The automated security response module 156 may function to transmit security response/control instructions to the one or more surveillance sensing devices 110 for appropriate remediation, mitigation, or handling of the potential security activity. In a preferred embodiment, which will be described in more detail in method 200, the security response instructions that are transmitted to the one or more surveillance sensing devices 110 may be based on an evaluation of a computed threat severity score (and/or the computed threat-informative inferences).

In some embodiments, the security control/mitigation instructions that may be transmitted to the one or more surveillance sensing device(s) 110 may include, but may not be limited to, instructions for playing/displaying a specified warning message (e.g., “Police will be notified if you do not leave the property in the next 30 seconds”), instructions for adjusting the pan, tilt, and/or zoom (PTZ) of the surveillance sensing device, instructions for playing a (e.g., loud) security alarm tone, instructions for notifying a pre-defined security team, instructions for calling the subscriber, instructions to ignore the potential security activity, playing a crime deterrent noise/sound (e.g., dog barking sound), activating a particular function of the surveillance sensing device (e.g., turning a flood light on, intermittent bursts of flashing (e.g., red) lights) and/or the like.

Additionally, or alternatively, the AI inference and security response subsystem 140 may implement one or more ensembles of trained machine learning models. The one or more ensembles of machine learning models may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a machine learning classifier, computer vision model, convolutional neural network (e.g., ResNet), visual transformer model (e.g., ViT), object detection model (e.g., R-CNN, YOLO, etc.), regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a semantic image segmentation model, an image instance segmentation model, a panoptic segmentation model, a keypoint detection model, a person segmentation model, an image captioning model, a 3D reconstruction model, a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation from transformers (BERT) for masked language model tasks and next sentence prediction tasks and the like, variations of BERT (i.e., ULMFiT, XLM UDify, MT-DNN, SpanBERT, RoBERTa, XLNet, ERNIE, KnowBERT, VideoBERT, ERNIE BERT-wwm, MobileBERT, TinyBERT, GPT, GPT-2, GPT-3, GPT-4 (and all subsequent iterations), ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be implemented in the various systems and/or methods described herein.

### 2.00 Method for Automatically Evaluating Security Events and Mitigating Detected Security Threats

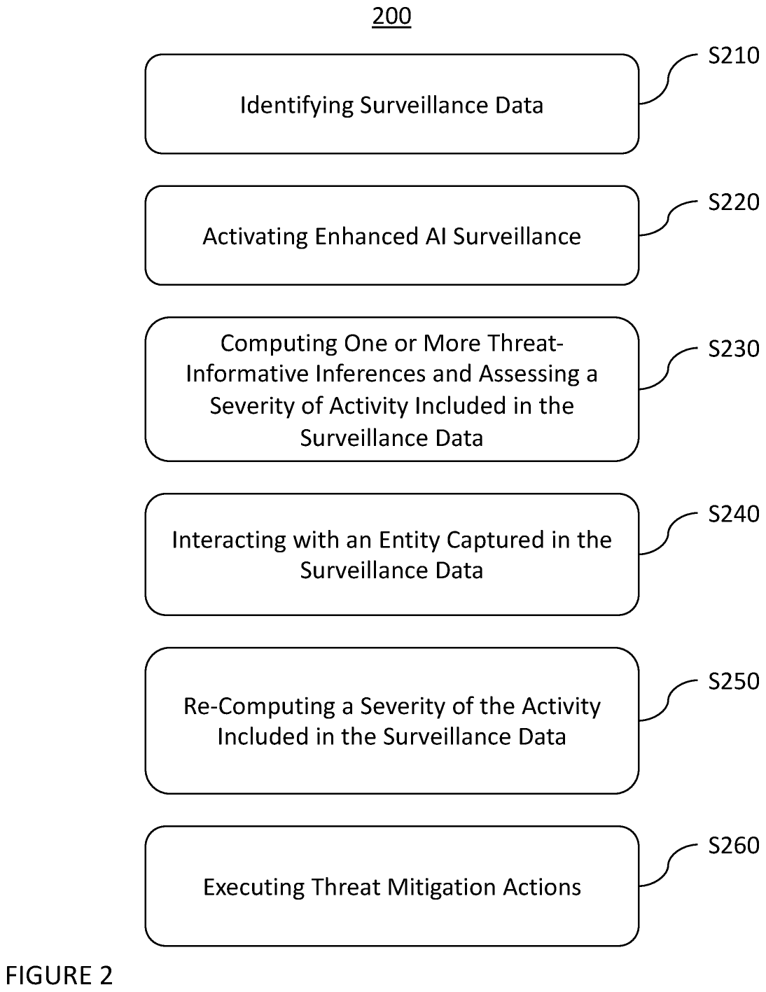

As shown in FIG. 2, the method 200 for detecting and responding to a security event using a machine learning controlled security device identifying surveillance data (S210), activating enhanced AI surveillance (S220), computing one or more machine learning security threat inferences and assessing the severity of activity based on the surveillance data (S230), controlling a security device based on the machine learning threat inferences (S240), iteratively computing a severity of the activity based on updated surveillance data (S250), and executing threat mitigation actions (S260).

### 2.10 Identifying Surveillance Data

S210, which includes identifying surveillance data, may function to source or identify a corpus of surveillance data corresponding to a potential security activity. That is, in some embodiments, S210 may function to obtain surveillance data that potentially relates to an activity having a likelihood or probability of being harmful, threatening, and/or adverse to a subscriber subscribing to the system 100 (or to a property/asset of the subscriber).

In one or more embodiments, S210 may function to identify the surveillance data via a surveillance sensing device (or a plurality of surveillance sensing devices). For instance, in a non-limiting example, a surveillance sensing device, such as a surveillance camera, may respond to, activate, and/or detect a potential security activity based on a motion sensor, heat sensor, proximity sensor, light sensor, or any other suitable sensor of the surveillance sensing device, and in response, automatically begin transmitting surveillance data corresponding to the detected potential security activity. It shall be noted that that the surveillance data identified via the surveillance sensing device may include, but may not be limited to, audio data of the potential security activity, image data of the potential security activity, video data of the potential security activity, infrared data of the potential security activity, and/or the like.

Alternatively, in some embodiments, after detecting the potential security activity, the surveillance sensing device may not immediately begin transmitting surveillance data of the potential security activity. Rather, in some such embodiments, the surveillance sensing device may only start transmitting surveillance data of the potential security activity after determining that the potential security activity satisfies surveillance transmission criteria or AI instantiation criteria. In a non-limiting example, the enhanced AI security module may be configured or programmed for activation when one or more predetermined criteria (e.g., activate at night, etc.) may be satisfied. In such example, the surveillance sensing device may detect or identify a potential security event and evaluate contextual data (e.g., time of day) associated with the potential security event against AI instantiation criteria or the like (e.g., transmit at night). Accordingly, if it is determined that the AI instantiation criteria may not be satisfied (because it is not nighttime), the surveillance sensing device may opt not to transmit surveillance data related to the potential security event and, in some circumstances, merely capture and store the surveillance data for a potential security review and/or the like.

In some embodiments, the surveillance sensing device may determine that the surveillance transmission criteria is satisfied if at least one human body may likely be detected within a sensing region/field-of-view of the surveillance sensing device. In such embodiments, to detect if at least one body may be located within the sensing region/field-of-view of the surveillance sensing device, the surveillance sensing device may generate a visual representation (e.g., image) of the detected potential security activity and provide, as input, the generated visual representation to a body or object detection machine learning model (e.g., neural network). In turn, the body detection machine learning model may function to predict whether the identified visual representation includes one or more bodies and delineate the one or more bodies from other objects in the generated representation, if appropriate.

It shall be noted that the above example is not intended to be limiting and that the surveillance transmission criteria may or may not be satisfied based on additional, fewer, or different criterion without departing from the scope of the invention(s) contemplated herein. That is, any suitable criterion may be set or configured for automatically causing the sensing device to transmit surveillance data including, but not limited to, time-of-day parameters, third-party data (e.g., recent crime news or activity), activation or intervention by a registered user, and/or the like.

It shall also be noted that, in some embodiments, S210 may reference rules/conditions defined by the subscriber (or by an administrator appointed by the subscriber) to determine if the potential security activity satisfies surveillance transmission criteria. In some such embodiments, the system 100 may function to encode or program the surveillance sensing device with such rules/conditions based on input from the subscriber or the administrator via one or more user interfaces of a subscriber-accessible application provided by the system 100. For instance, as a non-limiting example, a subscriber may be able to define, via the one or more user interfaces of the system-provided application, that a potential security activity detected by a surveillance sensing device satisfies surveillance transmission criteria if the potential security activity includes at least one body and does not satisfy the surveillance transmission criteria if the potential security activity does not include at least one body.

Contextualizing the Potential Security Activity

In some embodiments, after or contemporaneous with identifying surveillance data associated with a potential security activity, S210 may further function to source or derive data for contextualizing the potential security activity (“contextual metadata”). It shall be noted that, in some embodiments involving a surveillance sensing device (or a plurality of communicating or networked surveillance sensing devices), S210 may function to source contextual metadata for each potential security activity detected by the surveillance sensing device or may function to only source contextual metadata for each potential security activity that satisfies surveillance transmission criteria.

Example contextual metadata that S210 may source or derive for the identified surveillance data will be described below. However, it shall be noted that the described example contextual metadata is not intended to be limiting and that S210 may function to source/derive fewer, different, or additional data for contextualizing the identified surveillance data without departing from the scope of the invention(s) contemplated herein. Further, it shall also be noted that the contextual metadata sourced or derived by S210 may be obtained from the surveillance sensing device (e.g., via an operating system of the surveillance sensing device), obtained from a remote server (e.g., via API communication protocols), and/or obtained from a server in communication with the surveillance sensing device (e.g., as described in system 100).

In some embodiments, the contextual metadata sourced/derived by S210 may include data relating to a location of the subscriber when the surveillance device detected the potential security activity, may include data relating to a distance between the location of the subscriber and a location of the surveillance sensing device that detected the potential security activity, may include data relating to a time of day when the surveillance sensing device detected the potential security activity, may include data indicating if the potential security activity involves a human body, or the like. It shall be noted that, in some embodiments, S210 may function to generate one or more of the threat-informative inferences described in S230, and thus, data relating to those one or more threat-informative inferences may be included in the constructed contextual metadata.

### 2.20 Activating Enhanced AI Surveillance & Device Control

S220, which includes activating enhanced AI surveillance, may function to activate an enhanced AI surveillance and device control module for computing enhanced on-premise device control instructions for governing interactions with entities within a surveillance environment based on a determination that the surveillance data identified in S210 requires a threat assessment or the like. In a preferred implementation, the enhanced AI surveillance module may be implemented via a distributed network of computers (e.g., cloud computing or similar remote computing environment). Additionally, or alternatively, the enhanced AI surveillance module may be implemented via an on-premise server or computer distinct from the on-premise device. In a further alternatively, all or at least part of the enhanced AI surveillance module may be implemented via one or more embedded systems of the on-premise device.

In some embodiments, S220 may function to evaluate the contextual metadata generated for the surveillance data in S210 and activate the enhanced AI surveillance module in response to determining that the contextual metadata indicates enhanced analysis of circumstances of the security activity may be warranted/necessary (e.g., satisfying activation criteria of the enhanced AI surveillance module).

In some embodiments, S220 may determine that the surveillance data identified in S210 requires a threat assessment if the corresponding contextual metadata indicates that the potential security activity occurred after or during a defined or a particular time of day and/or indicates that the surveillance data includes a predefined object (e.g., a human body or the like). It shall be noted that in addition, or as an alternative, to the embodiments described above, S220 may function to automatically activate the enhanced AI surveillance module in response to S210 identifying that the detected potential security activity satisfies the above-described surveillance transmission criteria.

In some embodiments, the distributed network of computers that implement the enhanced AI surveillance module may be hosted by one or more cloud service providers (e.g., Amazon Web Services (AWS), Google Cloud Platform (GCP), IBM Cloud, or Microsoft Azure). Accordingly, in some such embodiments, to activate or instantiate the enhanced AI surveillance module, a surveillance sensing device (e.g., an AI security camera) may transmit a wake or instantiation signal to the distributed network of cloud-based computers. Subsequently, the wake or instantiation signal may be received by a security service or other system component operating the distributed network of cloud-based computers and may, in turn, cause the distributed network of cloud-based computers to activate an instance of the enhanced AI surveillance module (if previously instantiated) or instantiate the enhanced AI surveillance module (if not previously instantiated).

In some embodiments, S220 may further function to establish a bi-directional security device control and/or communication channel/session between the surveillance sensing device (or a plurality of surveillance sensing devices) and the enhanced AI surveillance module based at least in part on waking or instantiating the enhanced AI surveillance module. In a preferred embodiment, a software agent operating on the surveillance sensing device may function to establish a cryptographically secure channel for transmitting surveillance data to the AI surveillance module and for receiving device control instructions that, when executed, causes the surveillance sensing device to operate responsively to events or circumstances associated with the potential security activity. In one or more embodiments, the bi-directional communication channel may enable the surveillance sensing device (or the plurality of surveillance sensing devices) to stream surveillance data and/or the generated contextual metadata to the enhanced AI surveillance module for real-time or near real-time evaluation, as will be described in more detail herein. Furthermore, the bi-directional communication channel may also enable the enhanced AI surveillance module to transmit, to the one or more surveillance sensing devices, instructions/commands for appropriately addressing the detected potential security activity (as will also be described in more detail herein).

Additionally, or alternatively, the enhanced AI surveillance module may include or function to operate an ensemble of distinct machine learning models that, when implemented, generate a plurality of distinct inferences for handling the potential security activity and/or mitigating a security threat associated with the potential security activity. That is, the machine learning threat inferences may inform a generation of device control instructions and/or inform a selection of a device control sequence or automated security response workflow.

### 2.30 Computing Threat-Informative Inferences|Estimating Threat-Severity

S230, which includes computing one or more threat-informative inferences and assessing a threat level (i.e., threat-severity) of the potential security activity, may function to estimate a severity of the threat posed by the identified potential security activity based on the one or more computed threat-informative inferences. That is, in some embodiments, in response to the enhanced AI surveillance module receiving surveillance data from one or more surveillance sensing devices, S230 may function to estimate a severity of the activity identified in the surveillance data based on outputs and/or inferences of one or more machine learning models underpinning the enhanced AI surveillance module. Accordingly, a threat level and/or a threat-severity prediction preferably relates to an estimation of a probability and/or a likelihood that a potential security activity includes a threat of harm.

In one or more embodiments, S230 may function to derive or define a corpus of threat features based on extracting a plurality of distinct features from a corpus of surveillance data. In such embodiments, S230 may function to implement a feature extractor that may be trained and/or encoded to identify and extract a plurality of distinct features from the surveillance data having a likelihood or a probability of increasing a threat severity of a potential security activity. In one or more embodiments, the corpus of threat features and/or a combination of other machine learning inferences may define input for computing or predicting a threat level and/or threat-severity of a subject potential security activity.

Weapon Recognition Inference

In one or more embodiments, the one or more threat-informative inferences computed in S230 may include one or more inferences relating to a probability that the surveillance data includes one or more classes of weapons. In some such embodiments, the enhanced AI surveillance module may function to implement a weapon detection/recognition machine learning model (e.g., a neural network) and S230 may function to provide features extracted from one or more frames of the received surveillance data to the weapon detection/recognition machine learning model as input to the weapon recognition machine learning model. In response to the weapon detection/recognition machine learning model receiving the feature corpus extracted from the one or more frames of the surveillance data as input, the weapon detection/recognition machine learning model may function to generate one or more predictions indicating whether one or more frames include one or more weapons, and if so, may additionally classify the one or more detected weapons into one or more weapon classes (e.g., knife, gun, baseball bat, or the like).

Identity Recognition Inference

In one or more embodiments, the one or more threat-informative inferences computed in S230 may include one or more inferences relating to an identity of one or more bodies identified in the surveillance data. In some such embodiments, the enhanced AI surveillance module may function to implement a head/face extraction module and a facial recognition machine learning model. The head/face extraction module of the enhanced AI surveillance module may function to extract an image of a head for each body detected in the received surveillance data and provide those extracted images to the facial recognition machine learning model. In turn, the facial recognition machine learning model may function to produce, as output, an identity corresponding to each image provided as input.

It shall be noted that the faces recognizable by the facial recognition machine learning model may correspond to the photos/images provided, by the subscriber, to the system 100 during an initial enrollment period (e.g., via the previously-described application provided by the system 100). These provided photos/images may include photos of “welcomed” individuals (e.g., known-friendly, non-hostile individuals) and “un-welcomed” individuals (e.g., known-adversarial, known-hostile individuals). Accordingly, in some such embodiments, the enhanced AI surveillance module may not only compute an identity for the one or more bodies detected in the received surveillance data, but also classify each of the one or more bodies as friendly or adversarial.

It shall also be noted that, in some situations, the facial recognition machine learning model may be unable to compute an identity of a body detected in the received surveillance data. This may be because the face of the body is unfamiliar/unknown to the facial recognition module. In such situations, the enhanced AI surveillance module may function to perform additional processing to determine an identity of the body and if that body is “known-friendly” or “known-adversarial.” For instance, the enhanced AI surveillance module may function to compare the image of the face of the un-identified body to public awareness registries (e.g., FBI most wanted registries, sex offender registries, or the like) until a match is determined or until no other registries can be searched. If a match is found, S230 may determine an identity for the body based on the matched record and/or identify if the body is “known-friendly” or “known-adversarial” based on the type of registry in which the match was found.

Acoustic Threat Detection Inference

In one or more embodiments, the one or more threat-informative inferences computed in S230 may include one or more inferences relating to a probability that the surveillance data includes one or more violent or threatening sounds (e.g., glass shattering, elevated voice, explosions, gunshot, or the like). In some such embodiments, the enhanced AI surveillance module may function to implement an acoustic threat detection machine learning model (e.g., a neural network) and provide one or more audio segments of the received surveillance data to the acoustic threat detection machine learning model as input. In response to the acoustic threat detection machine learning model receiving the one or more audio segments, the acoustic threat detection machine learning model may function to detect if those one or more audio segments include one or more threatening sounds, and if so, classify the one or more threatening sounds into one or more acoustic threat classes (e.g., explosion, elevated voice, glass shattering, gunshot, door banging, or the like).

Action Identification Inference

In one or more embodiments, the one or more threat-informative inferences computed in S230 may include one or more inferences relating to an action being performed by each body detected in the received surveillance data. In some such embodiments, the enhanced AI surveillance module may function to implement an action identification machine learning model to detect an action of a target body in the received surveillance data. The action identification machine learning model may function to compute an action corresponding to a target body (e.g., delivering mail, entering door, etc.) based on one or more frames of the surveillance data provided as input. Accordingly, in some embodiments where the surveillance data includes multiple bodies, the enhanced AI surveillance module may function to derive an action being performed by each of the multiple bodies by generating distinct motion sequences corresponding to each of the multiple bodies and providing each of the generated motion sequences as input to the action identification machine learning model.

Abnormal Condition Detection Inference

In one or more embodiments, the one or more threat-informative inferences computed in S230 may include one or more inferences relating to a probability that the surveillance data includes one or more atypical conditions (e.g., fire, smoke, or the like). In some such embodiments, the enhanced AI surveillance module may function to implement an “abnormal” condition detection/recognition machine learning model (e.g., a deep learning model) and provide one or more frames of the received surveillance data to the abnormal condition detection/recognition machine learning model. In response to the abnormal condition detection/recognition machine learning model receiving the one or more frames of the surveillance data, the abnormal condition detection/recognition machine learning model may function to detect if those one or more frames include abnormal conditions, and if so, classify the one or more detected abnormal conditions into one or more atypical classes (e.g., fire, smoke, open door, shattered glass, etc.).

Estimating Threat Severity

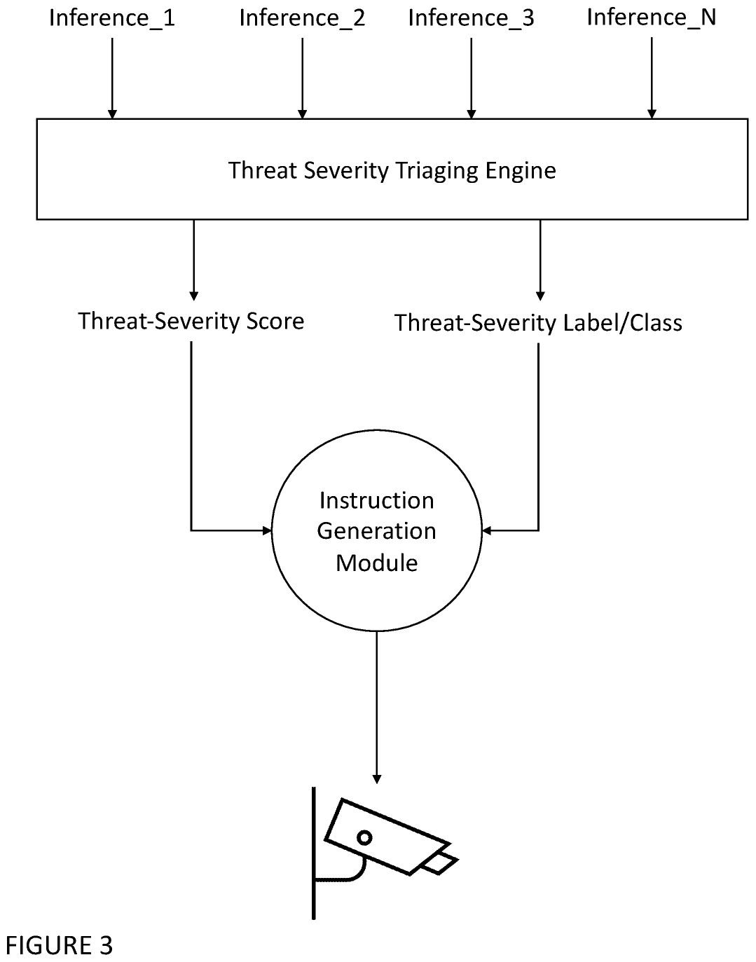

In some embodiments, after the enhanced AI surveillance module generates one or more threat-informative inferences for the received surveillance data, S230 may function to compute a threat-severity score for the activity identified in the surveillance data and/or classify the activity identified in the surveillance data as “malicious activity” or “non-malicious” activity based on the one or more threat-informative inferences, as generally illustrated in FIG. 3.

In a first implementation, to estimate a severity of the activity identified in the surveillance data, S230 may function to implement a severity-conscious machine learning ensemble specifically trained to compute a threat severity score and/or classify the intent of the activity identified in the surveillance data as malicious or non-malicious. In one or more embodiments, a composition of the severity-conscious machine learning ensemble may include a combination of distinct machine learning models producing the threat-informative inferences (e.g., weapon recognition model, identity recognition model, etc.). In some such embodiments, S230 may function to route one or more of the above-described threat-informative inferences to the severity-conscious machine learning ensemble or threat-severity classification layer (e.g., a classification head) of the ensemble, which in turn, may cause the severity-conscious machine learning ensemble to produce a threat-severity inference or prediction that may be converted or normalized (e.g., statistical-based normalization of the raw inference onto a pre-defined scale or threat score range) into a threat-severity score based on the provided input.

Accordingly, the threat-severity score produced by the severity-conscious machine learning model may be scaled between 0-100, wherein a threat-severity score of 0 indicates a 0% probability that activity identified in the surveillance data contains malicious activity and a threat-severity score of 100 indicates a 100% probability that activity identified in the surveillance data contains malicious activity.

Additionally, or alternatively, in a second implementation, S230 may function to estimate the severity of activity identified in the surveillance data via one or more heuristics/rules. For instance, in some such implementations, S230 may function to automatically estimate that the activity identified in the surveillance data contains malicious activity if S230 determines, via the one or more computed threat-informative inferences, that the surveillance data includes one or more weapons, includes one or more “un-welcomed” individuals, includes an acoustic threat (e.g., gunshot), includes an atypical condition/scenario (e.g., a fire), includes an unrecognized person, and/or includes a person listed on a public safety registry. That is, in this second implementation, S230 may function to estimate a threat-severity of a subject activity based on one or more features extracted from the activity scene and/or threat-informative inferences satisfying threat-severity logic (e.g., logic-1: if Weapon detected then increase threat severity estimate, etc.), threat-severity thresholds (e.g., human body in a threatening manner detected beyond a maximum period, etc.), and/or threat-severity rules (e.g., weapon+unidentified person=increased threat severity, etc.).

### 2.40 Device Engagement Control Instructions

S240, which includes generating device engagement control instructions, may function to generate device control instructions that, when executed by the security device, controls an engagement behavior of the security device with an entity involved in the potential security activity. In one or more embodiments, S240 may function to generate device engagement control instructions based on detecting an entity (e.g., a person) within a surveillance scene of the security device. Additionally, or alternatively, S240 may function to generate the device engagement control instructions contemporaneous with and/or based on the computation of the various security inferences and/or threat inferences of the enhanced AI module.

In a first example, S240 may function to generate device engagement control instructions based solely on the enhanced AI module using an objection detection machine learning algorithm that produces a security inference that indicates a probability of a presence of a person in the surveillance scene. In this first example, the security inference preferably informs a selection of one of a plurality of distinct automated security device engagement workflow or a generation of device engagement control instructions. In one or more embodiments, each of the plurality of distinct automated device engagement instructions may include a distinct sequence of instructions (actions) that, when executed by the security device, causes the security device to engage, interact, or respond to a target person within the surveillance scene in a distinct manner. In some embodiments, the generated device engagement control instructions may include a set of unique computer- or security device-executable instructions derived based on or informed by a confidence and/or probability value associated with the objection detection inference (i.e., the security inference). In such embodiments, S240 may function to implement a plurality of distinct engagement thresholds (e.g., a set or defined confidence or probability value) having a corresponding distinct engagement level or scale that, if or when satisfied by a confidence or a probability of the security inference, may cause or trigger S240 to automatically generate engagement instructions in a style or corresponding to the distinct engagement level or scale.

In a second example, S240 may function to generate device engagement control instructions based a security inference, such as an object detection inference, together with one or more threat inferences (e.g., weapon recognition, facial recognition, and/or the like). In this second example, S240 may additionally use threat inferences or factors to inform a generation device engagement instructions and/or a selection of one or more distinct automated engagement workflows. Accordingly, inferences of threat probability may factor in to increase or decrease engagement level or scale.

Entity Engagement|Execution of Engagement Control Instructions

Additionally, or alternatively, S240 may function to transmit, via the bi-directional control channel, the device engagement control instructions, which may be executed by an on-premise software security agent or security device.

In one or more embodiments, an execution of the engagement control instructions may function to control the security device to audibly prompt, using one or more output devices (e.g., one or more speakers), an intent-discovery question to an entity identified in the surveillance data and/or may function to collect a response to the intent-discovery question from the prompted entity. It shall be noted that, in some embodiments, one or more functions of S240 may be performed based on determining that the estimated severity score computed in S230 ambiguously indicates the maliciousness of the activity identified in the surveillance data (e.g., a severity score between 20 and 80). Conversely, it shall also be noted that, in some embodiments, one or more of the functions of S240 may not be executed, by the system 100 or service, and that one or more functions of S260 may be immediately executed, by the system 100, based on determining that the estimated severity score computed in S230 definitively indicates the maliciousness of activity identified in surveillance data (e.g., a severity score less than 20 or greater than 80).

In some embodiments, to prompt an intent-discovery question to an entity identified in the surveillance data, S240 may function to utilize the bi-directional communication channel/session established between the surveillance sensing device and the enhanced AI surveillance module in S220. In some such embodiments, the enhanced AI surveillance module may function to generate engagement instructions that include a generic intent-discovery question, such as “Hi, how can I help you?” or generate an intent-discovery based on one or more of the previously computed threat-informative inferences, such as “We have detected a gun in your left hand. Why is your gun unholstered?”.

After the enhanced AI surveillance module generates a relevant intent-discovery question, the intent-discovery question may be transmitted to the surveillance sensing device that detected the potential security activity via the established bi-direction communication channel/session. In turn, the surveillance sensing device may receive the intent-discovery question from the enhanced AI surveillance module and communicate the intent-discovery question to the one or more detected entities.

It shall be noted that, in some embodiments, communicating the intent-discovery question to the one or more detected entities may include audibly playing the intent-discovery question via a speaker of the surveillance sensing device, displaying the intent-discovery question via a display component of the surveillance sensing device, and/or the like.

Additionally, in some embodiments, after communicating the intent-discovery question to the one or more entities identified/detected by the surveillance sensing device, S240 may function to collect/identify a response from the one or more entities via a microphone of the surveillance sensing device and/or transmit the identified response to the enhanced AI surveillance module via the bidirectional communication channel. In such embodiments, the enhanced AI surveillance module may implement one or more natural language processing and/or natural language understanding algorithms or machine learning models to decipher the communication of the entity to build or generate suitable response or engagement control instructions. It shall also be noted that, in some embodiments, the entity detected by the surveillance sensing device may not provide a response to the intent-discovery question, and thus, the microphone of the surveillance sensing may not always detect a response from the entity. If the microphone of the surveillance sensing device does not detect a response from the entity within a target amount of time from communicating the intent-discovery question to the entity, the surveillance sensing device may transmit a signal to the enhanced AI surveillance module indicating the lack of response from the entity.

Furthermore, in some embodiments, based on the obtained response from the entity (or the lack of response from the entity), the enhanced AI surveillance module may function to generate one or more additional engage control instructions that may include intent-discovery questions and receive one or more response signals from the surveillance sensing device(s) until an intent of the entity can be unambiguously assessed by the enhanced AI surveillance module.

### 2.50 Re-Computing a Threat Severity

S250, which includes re-computing a severity of the potential security activity, may function to re-compute the severity of the potential security activity based on the response(s) to the intent-discovery question(s) posed in S240. That is, in some embodiments, S250 may function to re-estimate the severity of the potential security activity based on the conversational dialogue between the enhanced AI surveillance module and the one or more entities in S240.

It shall be recognized that the AI-based surveillance and security threat mitigation may be an iterative process in which the one or more steps of the method 200 may be continually performed to autonomously and accurately predict at least a threat severity based on real-time and/or new data surrounding and/or related to circumstances of a potential security activity. Accordingly, a re-computation of the severity of the potential security activity may be performed in real-time as new streams of data are identified and transmitted, via the bi-directional control communication channel thereby enabling the enhanced AI surveillance module to assess a security risk of the potential security activity and generate updated or new device control instructions for mitigating and/or handling a real-time threat.

In some embodiments, to re-compute the severity of the potential security activity, the enhanced AI surveillance module described in S220 may function to implement a machine learning-based conversational domain classifier. In some such embodiments, S250 may function to provide the machine learning-based conversational domain classifier the one or more intent-discovery questions posed in S240 and/or the one or more responses to the one or more intent-discovery questions also collected in S240. In turn, the machine learning-based conversational domain classifier may function to classify the overall conversation into one or more domains (e.g., solicitor domain, approved service-provider domain (e.g., gardener), unknown domain, or the like).

Based on the domain classification assigned to the conversation that occurred in S240, S250 may function to assign a new severity score to the potential security activity detected by the surveillance sensing device(s). For instance, in a non-limiting example, if the machine learning-based conversational domain classifier determined that the conversation occurring between an entity and the enhanced AI surveillance module is related to a first domain, S250 may function to update the original threat severity score assigned to the potential security activity in S230 to a new threat severity score.

It shall be recognized that a threat severity computation may be based on threat severity identification based on conversational inferences, S250 may additionally or alternatively re-compute the threat severity based on any suitable pieces or points of surveillance data.

It shall also be noted that, in some embodiments, the new threat-severity score assigned to the potential security activity may be higher or lower based on the determined domain. For instance, in a non-limiting example, if the machine learning-based conversational domain classifier determined that a domain could not be determined for the conversation that occurred in S240—which may indicate that the entity did not respond to the intent-discovery question(s) posed by the enhanced AI surveillance module—S250 may function to increase the threat-severity score of the potential security activity by a first amount. Alternatively, in another non-limiting example, if the machine learning-based conversational domain classifier determined that the conversation occurring in S240 relates to a soliciting domain or an approved service provider domain, S250 may function to decrease the threat-severity score of the potential security activity by a second amount or by a third amount, lesser than the second amount, respectively.

### 2.60 Transmitting Security Response Instructions|Executing Threat Mitigation Actions

S260, which includes transmitting security response instructions, may function to transmit security response instructions to a target surveillance sensing device for appropriately remediating, mitigating, or handling the potential security activity. In a preferred embodiment, the security response instructions that are transmitted to the target surveillance sensing device may be based on an evaluation of the severity score (and/or the threat-informative inferences) computed for a potential security activity against one or more decisioning routes defined in one or more pre-configured automated security response workflows.

Automated Security Response Workflow Composition/Structure

In such a preferred embodiment, the one or more pre-configured automated security response workflows may include one or more decisioning routes directed to handling/processing the detected potential security activity as confirmed malicious activity, one or more decisioning routes directed to handling/processing the detected potential security activity as confirmed non-malicious activity, and/or one or more decisioning routes directed to handling the potential security activity as suspected malicious activity (e.g., requiring further analysis/review by the subscriber or a subscriber appointed entity). It shall be noted that some of the one or more pre-configured automated security response workflows may include each type of route described above while other pre-configured automated security response workflows may only include a subset of the route described above.

In one or more embodiments, the decisioning routes defined in a pre-configured automated security response workflow may correspond to a distinct route condition that governs when that associated route will be executed or triggered. Generally, the route conditions defined in an automated security response workflow may include any suitable security logic or triggering logic including one or more Boolean expressions that quantitatively evaluate the severity score computed for potential security activity in S230 (or S250) and/or that quantitatively evaluate the threat-informative inferences computed in S230 and/or threat features extracted from the corpus of surveillance data. For instance, in a non-limiting example, an exemplary automated security response workflow may include a plurality of decisioning routes corresponding to a plurality of route conditions. In such an example, a first route of the plurality of decisioning routes may correspond to a first route condition that may be satisfied if the threat severity score computed for the potential security activity is greater than a first pre-determined threshold and/or if one or more of the computed threat-informative inferences satisfy one or more other pre-determined thresholds. It shall be noted that the other routes of the automated security response workflow may be executed (or not executed), by the method 200, for similar reasons described above. In another example, a second route of the plurality of decisioning routes may include a second route condition that includes (a) a threshold threat severity score and (b) a distinct threat feature (e.g., weapon detected) or security feature (e.g., person ID unknown) that may be logically combined, such that if satisfied triggers security response instructions or an automated security response workflow corresponding to the second route condition.

It shall also be noted that, in some embodiments, the route conditions defined in an automated security response workflow may be mutually exclusive from each other, such that the potential security activity may only be processed as confirmed malicious activity, confirmed non-malicious activity, or suspected malicious activity, but not a combination thereof.

Transmitting Security Response Instructions

Accordingly, the security response instructions ultimately transmitted to a surveillance sensing device for addressing the potential security activity depends on which route condition(s) in the one or more automated security response workflows are satisfied. For instance, if S260 detects that that severity score and/or the threat-informative inferences computed for the potential security activity satisfy a route condition of a first decisioning route, S260 may function to transmit, to a surveillance sensing device, the security mitigation instructions defined in the first decisioning route. Conversely, if S260 detects that that severity score and/or the threat-informative inferences computed for the potential security activity satisfy a route condition corresponding to a second, third, fourth, fifth, or the like decisioning route, S260 may function to transmit, to a surveillance sensing device, the security mitigation instructions defined in the second, third, fourth, fifth, or the like decisioning route.

In some embodiments, the security mitigation instructions that may be transmitted to the surveillance sensing device(s) may include, but may not be limited to, device control instructions for playing/displaying a specified warning message (e.g., “Police will be notified if you do not leave the property in the next 30 seconds”), instructions for adjusting the pan, tilt, and/or zoom (PTZ) configuration of the surveillance sensing device, instructions for playing a (e.g., loud) security alarm tone, instructions for notifying a pre-defined security team, instructions for calling the subscriber, instructions to not react to (e.g., ignore) the potential security activity and/or the like.

### 3. Computer-Implemented Method and Computer Program Product

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

Although omitted for conciseness, the preferred embodiments may include every combination and permutation of the implementations of the systems and methods described herein.

As a person skilled in the art will recognize from the previous detailed description and from the figures and claims, modifications and changes can be made to the preferred embodiments of the invention without departing from the scope of this invention defined in the following claims.

We claim:

1. A machine learning-based method for an automated control of a security device that assesses a security threat and intelligently executes security threat mitigating actions, the method comprising:
implementing an on-premise security device that detects a potential security activity at a property of a subscriber based on sensing a dynamic object within a defined range of the on-premise security device;
establishing a bi-directional device control security channel between the on-premise security device and a remote machine learning-based security module operating in a cloud computing environment if the potential security activity satisfies escalation criteria;
automatically transmitting, via the bi-directional device control security channel, sensor data from the on-premise security device to the remote machine learning-based security module;
computing, by the remote machine learning-based security module, a threat severity inference based on the sensor data, wherein the threat severity inference relates to a machine learning-based probability that the potential security activity poses a threat to the property of the subscriber or to an object/person associated with the property;
deriving device control instructions based on the threat severity inference, wherein the device control instructions, when executed by the on-premise security device, controls one or more response actions of the on-premise security device to the potential security event;
transmitting, via the bi-directional device control security channel, the device control instructions to the on-premise security device; and
mitigating the potential security activity by executing the device control instructions at the on-premise security device.

2. The method of claim 1, wherein:
the escalation criteria comprise a human detection inference value, and
the potential security activity satisfies the escalation criteria if a human detection inference generated by the remote machine learning-based security module satisfies the human detection inference value indicating a presence of at least one human body.

3. The method of claim 1, wherein:
the escalation criteria comprise a time-of-day range, and
the potential security activity satisfies the escalation criteria if the remote machine learning-based security module device determines that the potential security activity occurred after a pre-determined time of day during the time-of-day range.

4. The method of claim 1, wherein the escalation criteria are defined by the subscriber, the method further comprising:
receiving, from the subscriber, an input including one or more criteria defining when a target potential security activity satisfies and does not satisfy the escalation criteria; and
in response to receiving the input, setting the escalation criteria with the remote machine learning-based security module based on the one or more criteria provided by the subscriber.

5. The method of claim 1, further comprising:
determining that the potential security activity does not satisfy the escalation criteria; and
in response to determining that the potential security activity does not satisfy the escalation criteria, terminating a transmission of the sensor data to the remote machine learning-based security module.

6. The method of claim 1, wherein:
the on-premise security device includes at least one camera and at least one microphone, and
the sensor data from the on-premise security device includes data captured by the at least one camera and the at least one microphone during the potential security activity was detected.

7. The method of claim 1, wherein the remote machine learning-based security module includes a plurality of distinct machine learning-based submodules, including a first machine learning-based submodule that computes the threat severity inference and one or more context-generating machine learning-based submodules that generate context classification inferences associated with the potential security activity,
the method further comprising:
contemporaneous with computing the threat severity inference, generating one or more context classification inferences for the potential security activity by providing the sensor data transmitted from the on-premise security device to the one or more context-generating machine learning-based submodules;
routing the one or more context classification inferences as input to the first machine learning-based submodule; and
computing, via the first machine learning-based submodule, the threat severity inference based on the one or more context classification inferences.

8. The method of claim 7, wherein:
the sensor data comprises audio/video (AV) surveillance data of the potential security activity,
the one or more context-generating machine learning-based submodules that contextualize the potential security activity implement at least a weapon detection machine learning model, and
generating the one or more context classification inferences for the potential security activity includes:
providing, as input to the weapon detection machine learning model, a feature corpus extracted from the one or more video frames and/or audio data underpinning the audio/video surveillance data; and
producing, via the weapon detection machine learning model, a weapon classification inference indicating a likelihood the audio/video surveillance data includes at least one weapon based on the one or more video frames and/or audio data.

9. The method of claim 7, wherein:
the sensor data comprises audio/video (AV) surveillance data of the potential security activity,
the one or more context-generating machine-learning based submodules that contextualize the potential security activity implement at least an identity recognition machine learning model, and
generating the one or more context classification inferences for the potential security activity includes:
providing, as input to the identity recognition machine learning model, a feature corpus extracted from the one or more video frames and/or audio data underpinning the audio/video surveillance data; and
producing, via the identity recognition machine learning model, one or more context classification inferences indicating an estimated identity of each body in the audio/video surveillance data based on the one or more video frames and/or audio data.

10. The method of claim 9, wherein the identity recognition machine learning model is trained to recognize identities based on facial images previously provided by the subscriber, the method further comprising:
determining that the identity recognition machine learning model could not recognize an identity for at least one body in the audio/video surveillance data; and
in response to determining that the identity recognition machine learning could not recognize the identity for the at least one body in the audio/video surveillance data:
querying a public safety awareness registry based on an extracted image of a face of the at least one body; and
deriving an identity of the at least one body if the extracted image of the face of the at least one body matches an image of a face stored in the public safety awareness registry.

11. The method of claim 7, wherein:
the sensor data comprises audio/video (AV) surveillance data of the potential security activity,
the one or more other machine learning-based submodules that contextualize the potential security activity implement an acoustic threat detection machine learning model, and
generating the one or more context classification inferences for the potential security activity includes:
providing, as input to the acoustic threat detection machine learning model, a feature corpus extracted from the one or more audio frames underpinning the audio/video surveillance data; and
producing, via the acoustic threat detection machine learning model, an acoustic classification inference indicating a likelihood the audio/video surveillance data includes at least one acoustic threat based on the one or more audio frames.

12. The method of claim 1, wherein deriving device control instructions based on the threat severity inference includes:
in accordance with a determination that the threat severity inference indicates a first probability that the potential security activity poses a threat, selecting a first set of device control instructions for mitigating the potential security activity; and
in accordance with a determination that the threat severity inference indicates a second probability that the potential security activity poses a threat, selecting a second set of device control instructions for mitigating the potential security activity, different from the first set of device control instructions.

13. The method of claim 1, further comprising:
after computing the threat severity inference:
determining that the machine learning-based probability indicated by the threat-severity inference exists within a predefined probability range, wherein the predefined probability range only includes probabilities that ambiguously indicate whether the potential security activity poses a threat to the property of the subscriber or to an object/person associated with the property;
deriving device control instructions based on the threat severity inference, including deriving one or more intent-discovery questions;
transmitting, via the bi-directional device control security channel, the device control instructions, including the one or more intent-discovery questions;
playing, via one or more speakers of the on-premise security device, the one or more intent-discovery questions;
collecting, via a microphone of the on-premise security device, responses to the one or more intent-discovery questions;
transmitting, via the bi-directional device control security channel, the responses to the one or more intent-discovery questions to the remote machine learning-based security module;
computing, via the remote machine learning-based security module; a new threat-severity inference for potential security activity based on the responses to the one or more intent-discovery questions.

14. The method of claim 13, further comprising:
after computing the new threat-severity inference:
deriving new device control instructions based on the new threat-severity inference, wherein the new threat severity inference relates to an updated machine learning-based probability that the potential security activity poses a threat to the property of the subscriber or to an object/person associated with the property;
transmitting, via the bi-directional device control security channel, the new device control instructions to the on-premise security device; and
mitigating the potential security activity by executing the new device control instructions at the on-premise device.

15. The method of claim 13, wherein:
the remote machine learning-based security module includes a plurality of machine learning-based submodules, including one or more machine learning-based submodules that contextualize the potential security activity, the method further comprising:
contemporaneous with deriving the one or more intent-discovery questions, generating one or more context classification inferences for the potential security activity by providing a feature corpus extracted from the sensor data transmitted from the on-premise security device as input to the one or more machine learning-based submodules; and
deriving the one or more intent-discovery questions based at least on the one or more contextual inferences based on generating the one or more context classification inferences.

16. The method of claim 1, further comprising:
contemporaneous with computing the threat severity inference:
determining that the machine learning-based probability indicated by the threat-severity inference exists within a predefined probability range, wherein the predefined probability range only includes probabilities that indicate the potential security activity does not pose a threat to the property of the subscriber or to an object/person associated with the property; and
forgoing deriving the device control instructions and transmitting the device control instructions to the on-premise security device based on determining that the potential security activity does not pose a threat to the property of the subscriber or to the object/person associated with the property.

17. The method of claim 1, wherein:
implementing the on-premise security device includes an on-device software agent at the on-premise security device, separate from default operating system components of the on-premise security device, and
the on-device software agent establishes the bi-directional device control security channel.

18. The method of claim 17, wherein the on-premise security device comprises a security camera.

19. A method comprising:
detecting, via one or more surveillance sensing devices, a potential security activity involving at least one human body;
capturing, via the one or more surveillance sensing devices, audio/video surveillance data of the potential security activity;
streaming the audio/video surveillance data of the potential security activity to a cloud-based threat assessment module;
performing, at the cloud-based threat assessment module, a threat-severity assessment for the potential security activity based on the audio/video surveillance data, wherein performing the threat-severity assessment for the potential security activity includes:
providing, to one or more machine learning models instantiated in the cloud-based threat assessment module, one or more image frames and/or audio signals underpinning the audio/video surveillance data as input;
generating, via the one or more machine learning models, one or more threat-informative inferences based on the one or more image frames and/or audio signals provided as input; and
assigning a threat-severity score to the potential security activity based on the one or more threat-informative inferences;
engaging in an automated-conversational dialogue with the at least one human body involved in the potential security activity based on determining that the threat-severity score exists within a pre-determined threat-severity score range;
assigning a new threat-severity score to the potential security activity based on the automated-conversational dialogue with the at least one human body; and
automatically executing, via the one or more surveillance sensing devices, one or more security actions that mitigate the potential security activity based on the new threat-severity score assigned to the potential security activity.

20. A method comprising:
while one or more surveillance sensing devices are surveilling a property of a subscriber:
detecting a potential security activity at the property of the subscriber based on movement occurring within a sensing range of the one or more surveillance sensing devices;
determining that the potential security activity satisfies surveillance transmission criteria, wherein the potential security activity is determined to satisfy the surveillance transmission criteria if the potential security activity likely involves at least one human body;
capturing, via the one or more surveillance sensing devices, audio/video surveillance data of the potential security activity based on determining that the potential security activity satisfies the surveillance transmission criteria;
transmitting the audio/video surveillance data of the potential security activity to a cloud-based security threat evaluation system for enhanced processing of the potential security activity, wherein performing enhanced processing of the potential security activity via the cloud-based security threat evaluation system includes:
generating, via one or more machine learning models of the cloud-based surveillance threat evaluation system, one or more threat-informative inferences based on the audio/video surveillance data of the potential security activity; and
computing an aggregate threat-based severity score for the potential security activity based on the one or more threat-informative inferences;
prompting one or more intent-discovery questions to the at least one human body involved in the potential security activity based on determining that the aggregated threat-based severity score ambiguously indicates a maliciousness of the potential security activity;
updating the aggregate threat-based severity score assigned to the potential security activity based at least on responses provided to the one or more intent-discovery questions from the at least one human body; and
automatically executing, via the one or more surveillance sensing devices, one or more security actions that mitigate the potential security activity based on the updating of the aggregate threat-based severity score.
